(19) United States
(12) Patent Application Publication
(10) Pub. No.: US 2015/0116286 A1
(43) Pub. Date: Apr. 30, 2015

(54) TAG AND STABILIZER FOR STYLUS ATTACHMENT

(71) Applicant: Lenovo (Singapore) Pte. Ltd., Singapore (SG)

(72) Inventors: Aaron Michael Stewart, Raleigh, NC (US); Michaela Rose Case, Raleigh, NC (US); Christopher Miles Osborne, Cary, NC (US); Thomas John Sluchak, Apex, NC (US)

(73) Assignee: Lenovo (Singapore) Pte. Ltd., Singapore (SG)

(21) Appl. No.: 14/066,948

(22) Filed: Oct. 30, 2013

(51) Int. Cl. G06F 3/0354

(52) U.S. Cl. CPC G06F 3/03545
USPC 345/179

(57) ABSTRACT

An aspect provides a system, including: a stylus; one or more housing components containing a processor and a memory; a stylus input surface that registers input from the stylus using the processor and the memory; a tag protruding from the one or more housing components; and a stabilizing element incorporated into the one or more housing components; the stabilizing element configured to stabilize an end of the stylus when the stylus is disposed within the tag. Other aspects are described and claimed.

### BACKGROUND

Information handling devices (“devices”), for example laptop computers, tablets, smart phones, e-readers, etc., are often used with a stylus. Particularly, styluses or pens (hereinafter simply “stylus”) are utilized with mobile devices, e.g., smart phones, hand held computers, or other mobile platforms, as a mode of input. A stylus provides an additional input method allowing a user to provide inputs to a surface, e.g., a digitizer or a touch screen.

Conventionally during non-use, e.g., during transport of the device, the stylus is not tethered to the device but rather is secured in some way to the device, such that the stylus may be detached and utilized. Prior solutions for attaching or securing a stylus when not in use include providing a dock or slot into which the stylus is placed during non-use.

### BRIEF SUMMARY

In summary, one aspect provides a system, comprising: a stylus; one or more housing components containing a processor and a memory; a stylus input surface that registers input from said stylus using said processor and said memory; a tag protruding from said one or more housing components; and a stabilizing element incorporated into said one or more housing components; said stabilizing element configured to stabilize an end of the stylus when said stylus is disposed within said tag.

Another aspect provides a product, comprising: an accessory for attachment to an information handling device; a tag protruding from said accessory; and a stabilizing element incorporated into said accessory; said stabilizing element configured to stabilize an end of a stylus when said stylus is disposed within said tag.

A further aspect provides a system, comprising: a stylus; and an accessory for attachment to an information handling device; a tag protruding from said accessory; and a stabilizing element incorporated into said accessory; said stabilizing element configured to stabilize an end of a stylus when said stylus is disposed within said tag.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3(A-B) illustrates an example tag and stabilizer for stylus attachment.

FIG. 4(A-B) illustrates another example tag and stabilizer for stylus attachment.

FIG. 5(A-B) illustrates another example tag and stabilizer for stylus attachment.

FIG. 6(A-B) illustrates another example tag and stabilizer for stylus attachment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Current methods and arrangements for carrying a stylus with a device (e.g., tablet, smart phone, etc.) involve sliding the stylus into the device (e.g., sliding the stylus into a dock or slot provided by the device housing). However, with devices becoming smaller, and particularly with devices becoming slimmer, the provisioning of a dock or slot in the device housing is increasingly difficult, as space is at a premium. Moreover, this approach lends to making the stylus itself more “slim” or thin such that it may fit into the smaller dock or slot. Such approaches tend to sacrifice good ergonomics by reducing the stylus size in favor of retaining a slim overall device profile.

Accordingly, an embodiment provides a tag in tandem with a stabilizer to secure or attach (reversibly) the stylus to a device or a device accessory. In an embodiment, the tag is tapered or closed at one end thereof (similar to a holster). The stylus may thus be slid into the tag, e.g., tip first. If included on an accessory, e.g., a cover for a tablet device, the tag may serve multiple functions, e.g., securing the stylus tip and acting as a convenient place for the user to grasp to open the accessory.

In combination with the tag element, an embodiment provides a stabilizing or stabilization element, e.g., disposed a short length (e.g., ⅔ of the stylus length) away from the tag. The stabilizing element reversibly attracts or attaches to the stylus, e.g., at the other end (distal to the stylus tip). Therefore, the tandem pair of tag and stabilizing element adequately secures or attaches the stylus to the device housing or accessory while simultaneously accommodating a larger sized stylus (e.g., larger diameter) without negatively impacting the overall width profile of the device or accessory.

The illustrated example embodiments will be best understood by reference to the figures. The following description is intended only by way of example, and simply illustrates certain example embodiments. It should be noted as well that the figures include examples wherein a tag and stabilizing element are provided to an accessory. However, the same principles illustrated in the examples herein may be applied to other items, e.g., a device housing or the like, in addition to an accessory (e.g., tablet cover).

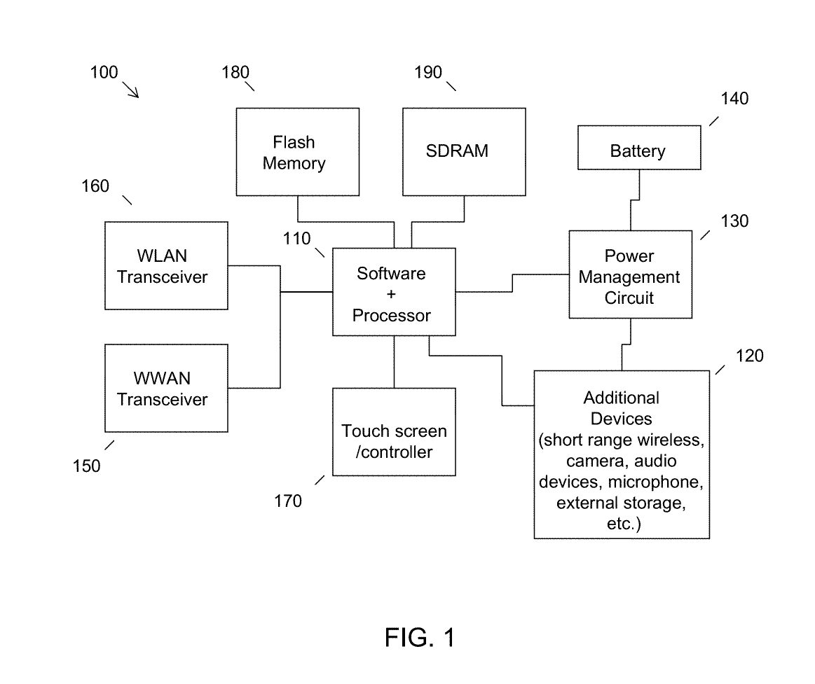

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Commonly, system 100 will include a touch screen 170 for data input and display. System 100 also typically includes various memory devices, for example flash memory 180 and SDRAM 190.

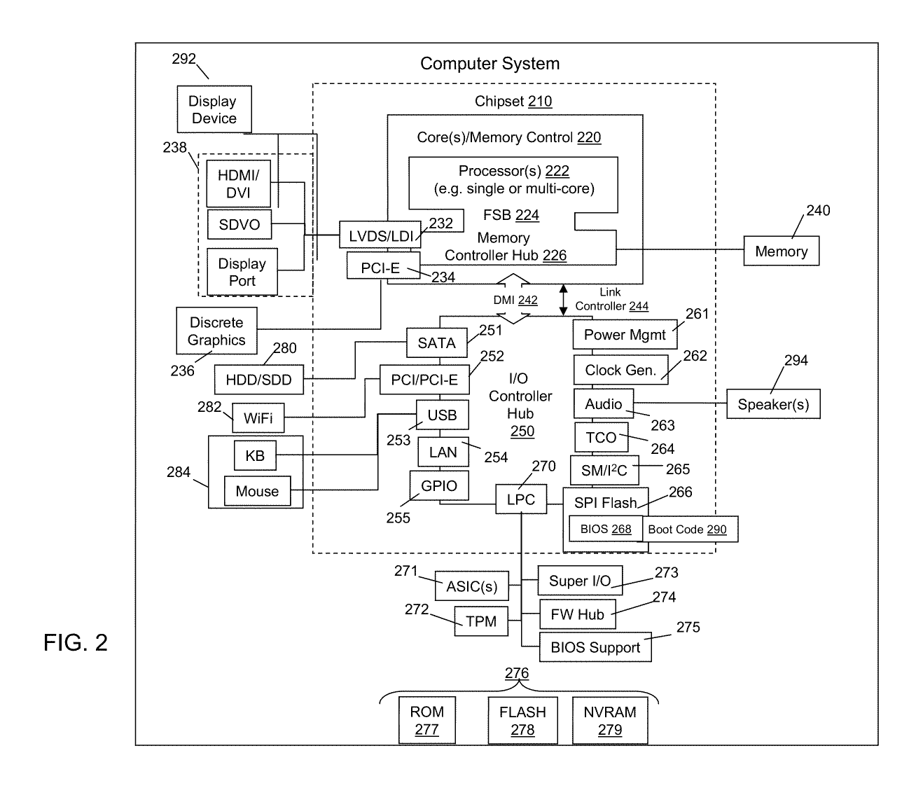

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 of FIG. 2, may used in connection with devices that operate to accept inputs via a stylus, e.g., via a stylus input surface such as a touch screen or a digitizer. Therefore, such devices may be utilized in various embodiments described herein. Below, various tag and stabilizing element pairs are described in connection with a tablet device, with the tag and stabilizing element being applied to the accessory of the device. Again, these are merely representative examples, and the tag and stabilizing element may be applied to a device housing, e.g., of a laptop, smart phone, tablet, etc. Moreover, other devices (e.g., smart phone rather than a “tablet”) may be utilized with such an accessory.

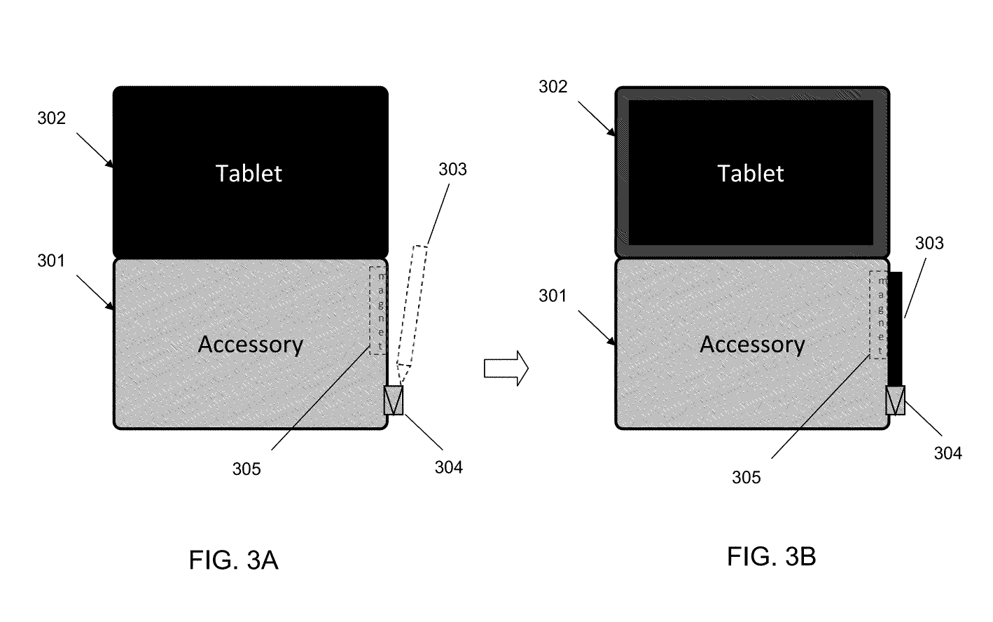

FIG. 3(A-B) illustrates an example embodiment in which an accessory 301 is provided with the device 302. The accessory 301 includes a tag 304 and a stabilizing element 305. Here, the stylus 303 may be guided into the open end of the tag 304. The tag 304 may be optionally closed at the other end, as illustrated.

Having secured the tip of the stylus 303 into the tag 304, a stabilizing element 305 placed appropriately serves to stably secure or attach the stylus 303 to the accessory 301. In the example of FIG. 3(A-B) the stabilizing element 305 may be located in the accessory 301 along an edge thereof, somewhat spaced from the location of the tag 304. Thus, the stabilizing element 305 acts to secure the other end of the stylus 303. For example, the stabilizing element 305 may include a magnet disposed in the accessory 301 such that a metallic stylus 303 is attracted thereto. Thus, when the tip of the stylus 303 is guided into the tag 304, the stylus 303 will be attracted to and snap into place by virtue of the stabilizing element 305, as illustrated in FIG. 3B.

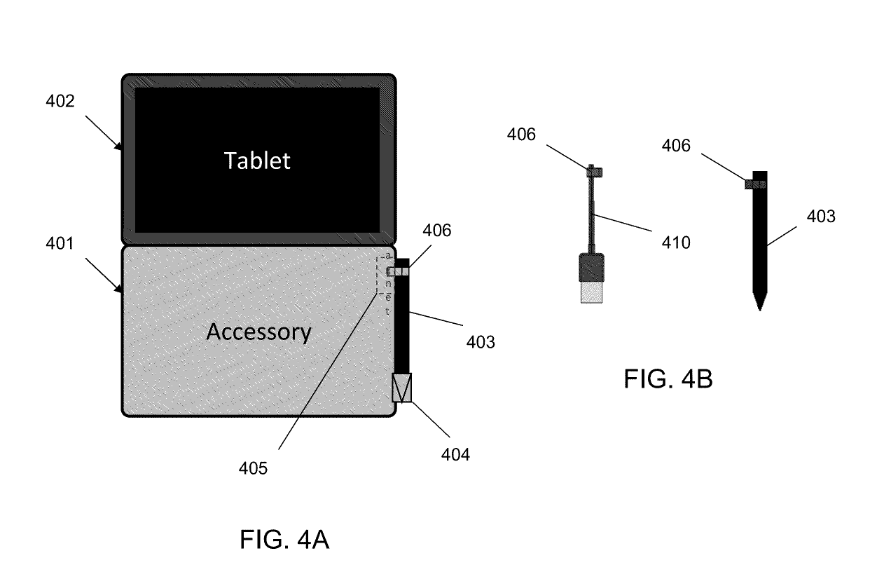

FIG. 4(A-B) illustrates another example embodiment. Here, the stabilizing element 405 is again disposed within the accessory 401, e.g., acting as a cover of a tablet device 402. The stabilizing element 405 in this embodiment may take the form of an aperture or depression in the accessory 401. The aperture or depression of the stabilizing element 405 may be keyed, e.g., to be complimentary to a protrusion or protruding element 406 of the stylus 403. The protrusion 406 may be configured as a standardized shape or element such that other items, e.g., USB cable 410 clip, may be used as the protruding element 406. This facilitates using common items for more than one purpose. Again, the accessory 401 may therefore include a stabilizing element 405 that acts to secure a protrusion 406 of the stylus 403 such that the stylus 403 may be guided into the tag 404 and clipped or secured into the stabilizing element 405 via fitting protrusion 406 into the stabilizing element 405.

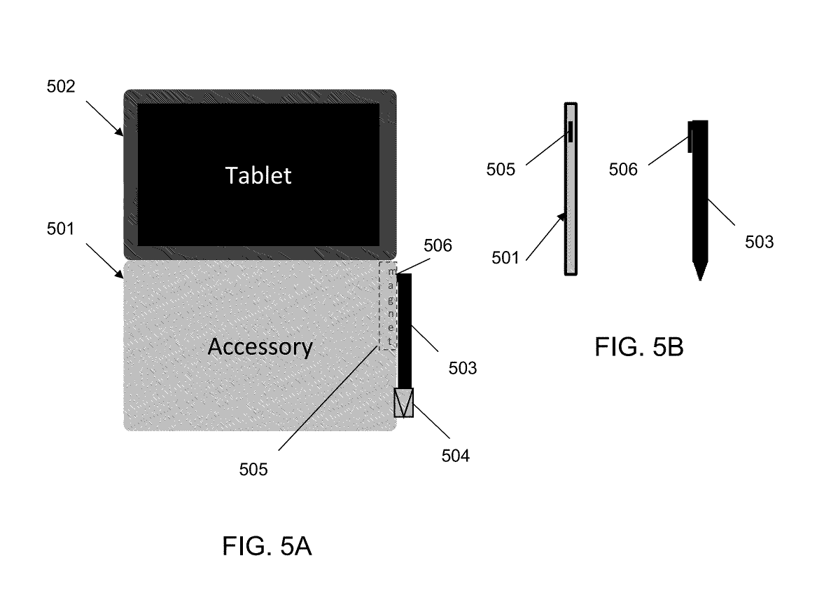

FIG. 5(A-B) illustrates another example embodiment. Here, the accessory 501 of a tablet device 502 includes a stabilizing element 505 in the form of a slot. The slot shaped stabilizing element 505 provides a space into which a protrusion 506 of the stylus 503 may be fit. Thus, the tip of the stylus 503 may be guided into the open end to the tag 504 and the protrusion 506 fit or snapped into place within the stabilizing element 505 of the accessory 501. FIG. 5B illustrates a side view of the accessory 501 including slot shaped stabilizing element 505 and a view of the stylus 503 having a protrusion 506, e.g., shaped similar to a pen clip on a traditional ink pen. Thus, protrusion 506 may be slid into the stabilizing element 505, e.g., similar to sliding the clip of a traditional pen into a hole or cavity of the accessory 501.

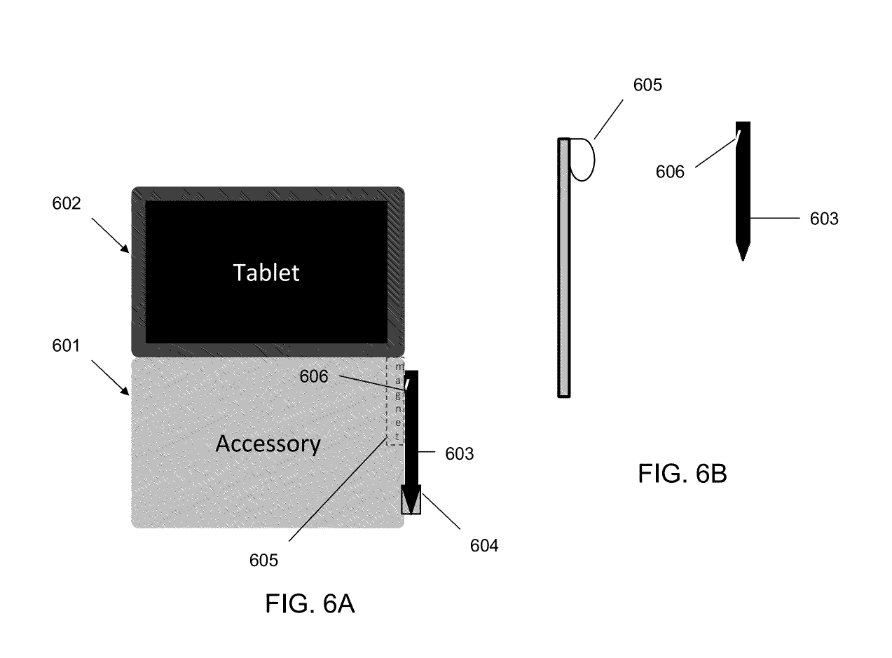

FIG. 6(A-B) illustrates another example embodiment. Here, the accessory 601 of a tablet device 602 includes a stabilizing element 605 in the form of a loop. The loop shaped stabilizing element 505 may placed on the accessory 501 such that when the stylus 603 tip is guided into the tag 604 a slot or like depression 606 in the stylus 603 catches the loop shaped stabilizing element 606. This permits the stylus 603 to be securely retained or attached to the accessory 601 (or any other item containing the tag 604 and stabilizing element 605) in a reversible fashion. FIG. 6B illustrates a side view of the accessory 601 having a loop shaped stabilizing element 605 and a view of the stylus 603 having a slot 606 therein.

As will be appreciated, although a variety of tags and stabilizing elements have been described herein, these are non-limiting examples. Other tags or stabilizing elements may be utilized. For example, different shapes may be utilized for the tag and certain shapes may be used for other or additional purposes, e.g., branding. As another example, other forms of stabilizing elements may be utilized, e.g., hook and loop fasteners disposed on the accessory of device housing and the stylus that reversibly attach to one another. Moreover, the edge of the device housing or accessory containing the stabilizing element (e.g., magnet) may be shaped complimentary to the stylus, e.g., a spherical depression in the edge of the device housing or accessory that is circumferentially matched or complimentary to the shape of the stylus. Additionally, it will be appreciated that the various tag and stabilizing elements may be used in a variety of combinations other than the examples explicitly described and illustrated herein.

As used herein, the singular “a” and “an” may be construed as including the plural “one or more” unless clearly indicated otherwise.

Certain aspects are described herein with reference to the figures, which illustrate various example embodiments. This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system, comprising:
a stylus;
one or more housing components containing a processor and a memory;
a stylus input surface that registers input from said stylus using said processor and said memory;
a tag protruding from said one or more housing components; and
a stabilizing element incorporated into said one or more housing components;
said stabilizing element configured to stabilize an end of the stylus when said stylus is disposed within said tag.

2. The system of claim 1, wherein said tag covers no more than a minor portion of the stylus.

3. The system of claim 1, wherein said tag is closed at one end.

4. The system of claim 1, wherein the stabilizing element has an aperture therein for receiving an element of the stylus.

5. The system of claim 1, wherein the stabilizing element comprises a looped element.

6. The system of claim 1, wherein the stabilizing element comprises a hook and loop fastener.

7. The system of claim 1, wherein the stabilizing element comprises a protrusion for reversibly attaching to a keyed element of the stylus; and further wherein the keyed element of the stylus conforms to a standardized shape used for securing other components.

8. The system of claim 3, wherein the stabilizing element is a magnet.

9. The system of claim 1, wherein an edge of said one or more housing components incorporates said stabilizing element;
wherein said edge is shaped complimentary to circumferential profile of a stylus.

10. A product, comprising:
an accessory for attachment to an information handling device;
a tag protruding from said accessory; and
a stabilizing element incorporated into said accessory;
said stabilizing element configured to stabilize an end of a stylus when said stylus is disposed within said tag.

11. A system, comprising:
a stylus; and
an accessory for attachment to an information handling device;
a tag protruding from said accessory; and
a stabilizing element incorporated into said accessory;
said stabilizing element configured to stabilize an end of a stylus when said stylus is disposed within said tag.

12. The system of claim 11, wherein said tag covers no more than a minor portion of the stylus.

13. The system of claim 11, wherein said tag is closed at one end.

14. The system of claim 11, wherein the stabilizing element has an aperture therein for receiving an element of the stylus.

15. The system of claim 11, wherein the stabilizing element comprises a looped element.

16. The system of claim 11, wherein the stabilizing element comprises a hook and loop fastener.

17. The system of claim 11, wherein the stabilizing element comprises a protrusion for reversibly attaching to a keyed element of the stylus; and further wherein the keyed element of the stylus conforms to a standardized shape used for securing other components.

18. The system of claim 13, wherein the stabilizing element is a magnet.

19. The system of claim 11, wherein an edge of said accessory incorporates said stabilizing element.

20. The system of claim 19, wherein said edge is shaped complimentary to circumferential profile of a stylus.
